(19) United States
(12) Patent Application Publication
(10) Pub. No.: US 2026/0203199 A1
(43) Pub. Date: Jul. 16, 2026

(54) TECHNOLOGIES RELATED TO FAULT INJECTION IN COMPILED CODE

(71) Applicant: Dell Products L.P., Round Rock, TX (US)

(72) Inventor: Anton Rang, Houlton, WI (US)

(21) Appl. No.: 19/026,050

(22) Filed: Jan. 16, 2025

(51) Int. Cl. G06F 11/3668; G06F 9/32

(52) U.S. Cl. CPC G06F 11/3688; G06F 9/321; G06F 11/3684

(57) ABSTRACT

The subject technology relates to a method of compiling source code to facilitate fault injection. An example method may include integrating a built-in function into a compiler for a programming language configured to identify a fault injection point based on a name parameter, using the name parameter of the built-in function, and identifying a fault for injection at the fault injection point within source code. Further, the compiler can be used to compile the source code resulting in generated machine code that comprises the name parameter, and metadata can be generated for storage in an injection table to facilitate fault injection when executing the machine code. The metadata may include fields related to properties of the fault injection point, including a name field that comprises the name parameter, and a program counter field that identifies an address corresponding to the fault injection point within the machine code.

### BACKGROUND

The ability to inject faults into the execution of a program, such as by forcing an error code to be returned from a function even when no actual error has occurred, is used to test execution paths that are designed to handle and recover from errors. Traditionally, fault injection is accomplished by incorporating conditional execution statements, often in the form of “if statements,” at specific points in the code where an error is to be simulated during testing. These if statements check for a fault-injection condition and then simulate the error.

The above-described context with respect to conventional computing systems is merely intended to provide an overview of current technology and is not intended to be exhaustive. Other contextual description, and corresponding benefits of some of the various non-limiting embodiments described herein, will become further apparent upon review of the following detailed description.

### SUMMARY

The following presents a simplified summary of the disclosed subject matter to provide an understanding of various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method is described herein. The method may include integrating, by a device comprising at least one processor, a function into a compiler for a programming language, resulting in a built-in function. The built-in function may be configured to identify a fault injection point based on a name parameter specifying a name of the fault injection point. The method may further include using the name parameter of the built-in function, identifying, by the device, a fault for injection at the fault injection point within source code. The method may further include using, by the device, the compiler to compile the source code to generate machine code resulting in generated machine code and, as a result of which, as specified by the built-in function, the generated machine code comprises the name parameter. The method may further include generating, by the device, metadata, for storage in a data structure comprising an injection table data structure to facilitate fault injection when executing the generated machine code. The metadata may include fields related to properties of the fault injection point. The fields may include a name field that comprises the name parameter and a program counter field that identifies an address corresponding to the fault injection point within the generated machine code. The method may further include executing, by the device, the generated machine code. The executing may include determining the fields in the injection table data structure corresponding to the fault injection point. The executing may further include replacing, at the address identified by the program counter field and corresponding to the fault injection point within the generated machine code, an instruction with a replacement instruction configured to transfer control to injection code derived from the fields in the injection table data structure. The executing may further include, in response to reaching the fault injection point during execution of the generated machine code, transferring control, via operation of the replacement instruction, to the injection code, and then executing the instruction that was replaced by the replacement instruction.

In an example embodiment, a system is described herein. The system may include at least one processor and at least one memory that stores executable instructions that, when executed by the at least one processor, facilitate performance of operations. The operations may include integrating, by a device comprising at least one processor, a function into a compiler for a programming language, resulting in a built-in function. The built-in function may be configured to identify a fault injection point based on a name parameter specifying a name of the fault injection point. The operations may further include using the name parameter of the built-in function, identifying, by the device, a fault for injection at the fault injection point within source code. The operations may further include using, by the device, the compiler to compile the source code to generate machine code resulting in generated machine code and, as a result of which, as specified by the built-in function, the generated machine code comprises the name parameter. The operations may further include generating, by the device, metadata, for storage in a data structure comprising an injection table data structure to facilitate fault injection when executing the generated machine code. The metadata may include fields related to properties of the fault injection point. The fields may include a name field that comprises the name parameter and a program counter field that identifies an address corresponding to the fault injection point within the generated machine code. The operations may further include executing, by the device, the generated machine code. The executing may include determining the fields in the injection table data structure corresponding to the fault injection point. The executing may further include replacing, at the address identified by the program counter field and corresponding to the fault injection point within the generated machine code, an instruction with a replacement instruction configured to transfer control to injection code derived from the fields in the injection table data structure. The executing may further include, in response to reaching the fault injection point during execution of the generated machine code, transferring control, via operation of the replacement instruction, to the injection code, and then executing the instruction that was replaced by the replacement instruction.

In an example embodiment, a non-transitory machine-readable medium is described. The non-transitory machine-readable medium may include executable instructions that, when executed by at least one processor, facilitate performance of operations. The operations may include integrating a function into a compiler for a programming language to result in a built-in function. The built-in function may be configured to identify a fault injection point via parameters that include a name parameter specifying a name of the fault injection point and a variable parameter specifying a variable. The operations may further include identifying, using the name parameter and the variable parameter, a fault for injection at a fault injection point within source code. The operations may further include using the compiler to compile the source code to generate machine code as a result of which, as specified by the built-in function, the machine code includes the name parameter and variable parameter of the fault injection point. The operations may further include generating metadata in a data structure comprising an injection table data structure to facilitate a fault injection process applicable during execution of the machine code, the metadata comprising fields related to properties of the fault injection point. The fields may include a name field that comprises the name parameter. The fields may further include a program counter field that identifies an address corresponding to the fault injection point within the machine code. The fields may further include a variable location field that specifies a storage address for the variable. The fields may further include a variable type field that specifies a size or type of the variable. The operations may further include executing the machine code. The executing may include determining the fields in the injection table data structure that correspond to the fault injection point. The executing may further include replacing, at the program counter address corresponding to the fault injection point within the machine code, an instruction with a replacement instruction configured to transfer control to injection code derived from the fields from the injection table data structure. The executing may further include, based on the fault injection point being reached during the execution of the machine code, transferring control, via operation of the replacement instruction, to the injection code. The injection code may be configured to utilize the storage address specified in the injection table data structure to adjust a value of the variable to result in an adjusted value of the variable in accordance with the fault being injected. The executing may further include executing the instruction that was replaced by the replacement instruction.

To the accomplishment of the foregoing and related ends, the disclosed subject matter includes one or more of the features hereinafter more fully described. The following description and the annexed drawings set forth in detail certain illustrative embodiments of the subject matter. However, these embodiments are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Features and advantages of the present technique will become more apparent from the following detailed description of example embodiments thereof taken in conjunction with the accompanying drawings in which:

FIG. 1 illustrates a computer system with a compiler according to various example embodiments;

FIG. 2 illustrates a process for generating injection table entries when compiling source code according to various example embodiments;

FIG. 3 illustrates a process for generating injection table entries when compiling alternative source code according to various example embodiments;

FIG. 4 illustrates a process for generating injection table entries when compiling alternative source code according to various example embodiments;

FIG. 5 illustrates a process for generating injection table entries when compiling alternative source code according to various example embodiments;

FIG. 6 illustrates a method of compiling source code that includes a fault injection in which the fault does not include a variable according to various example embodiments;

FIG. 7 illustrates a method for executing the generated machine code of FIG. 6 according to various example embodiments;

FIG. 8 illustrates a method of compiling source code that includes a fault injection in which the fault includes a variable according to various example embodiments;

FIG. 9 illustrates a method for executing the generated machine code of FIG. 8 according to various example embodiments; and

FIG. 10 is an example of an embodiment of a computer system that may utilize the techniques described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments. Like reference numerals have been used to illustrate like components across the figures.

Injecting faults into a program's execution, such as by forcing an error code to be returned from a function despite no actual error occurring, is used to test the execution paths that are designed to handle and recover from errors. This process ensures that the error-handling mechanisms in the code are robust and function correctly under various conditions. As mentioned in the background, traditionally, fault injection is accomplished by incorporating conditional execution statements, often in the form of “if statements,” at specific points in the code where an error is to be simulated during testing. These if statements check for a fault-injection condition and then simulate the error.

However, if these fault-injection conditions are included in the final product, they impose a run-time cost. Alternatively, if fault-injection code is only added to a special build used for testing, a second build of the software may be implicated. As will be appreciated, this test build may have slightly different execution semantics compared to the actual released code due to the presence of fault-injection mechanisms. This can lead to discrepancies between testing and real-world use, as the two builds may not behave identically.

These run-time costs arise in two ways: directly, because the code will generally evaluate the fault-injection condition during execution, and indirectly, because the presence of additional conditional statements can increase the overall size of the code and negatively impact the branch predictor. The branch predictor is a CPU component that guesses the direction of branch instructions (like if statements) to improve execution speed. More branches can reduce the accuracy and efficiency of the branch predictor. Alternatively, if fault-injection code is only added to a special build used for testing, as mentioned, a second build of the software may be implicated. This test build may have slightly different execution semantics compared to the actual released code due to the presence of fault-injection mechanisms. Consequently, any tests involving fault injection would be performed on the test build rather than on the version of the software that will ultimately be deployed to customers. This can lead to discrepancies between testing and real-world use, as the two builds may not behave identically.

To address these shortcomings, the embodiments of the present disclosure propose to add functionality to the compiler that is used to translate source code to executable code. This functionality makes fault injection possible in released code, while associated run-time costs are reduced or eliminated altogether. For example, embodiments of the present disclosure introduce a new “built-in function” (shown below in source code examples as “builtin”) to a compiler, such as those for C or C++, but it can be extended to other programming languages that compile to machine code. The purpose of this function is to facilitate fault injection during program execution, which is crucial for testing error recovery mechanisms, while reducing or eliminating associated run-time cost. In certain embodiments, the built-in function may include two parameters: a name parameter for the injection point and a variable parameter whose value can be manipulated by the fault injection process. In other embodiments, the built-in function may use only one parameter. For example, in cases where the fault being injected is a delay rather than an error condition, the variable parameter may be omitted. In example embodiments, via the built-in function, the compiler of the present application is configured to ensure that a variable is live and volatile at the injection point. The compiler may further be configured to issue a warning if the variable is not live at the specified injection point, thereby providing a mechanism to alert the developer to potential issues. For local variables, the compiler of the present disclosure determines whether the variable is present in a register or located in memory at an offset from either the stack pointer or the frame pointer. If the variable is not local, the compiler assesses whether it is possible to reference the variable from an existing register or an in-memory value with an offset. In situations where the variable's address cannot be easily referenced, the compiler has the option to compute the variable's address into a register. However, it will be appreciated that this computation might introduce a performance impact, e.g., a run-time cost, though this impact is typically reduced over conventional methods. As an alternative, the compiler may choose to reject such cases to maintain zero-impact execution.

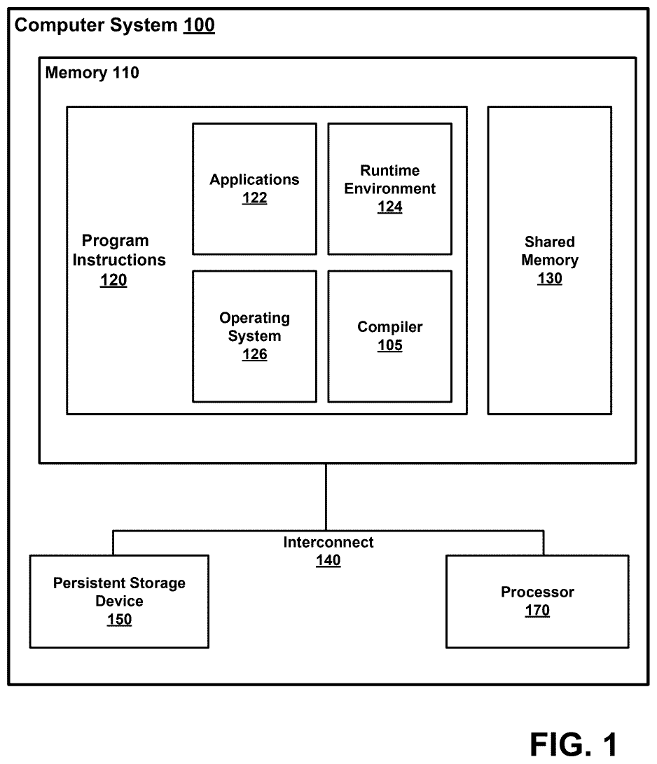

With reference to FIG. 1, a computer system 100 is illustrated that includes a compiler 105 configured to implement various embodiments. The computer system 100 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device. The compiling mechanisms of the compiler 105 may be provided as a computer program product, or software, that may include a computer-readable storage medium having stored thereon instructions, which may be used to program a computer system (or other electronic devices) to perform a process according to various embodiments described herein. A computer-readable storage medium may include any mechanism for storing information in a form (e.g., software, processing application) readable by a machine (e.g., a computer).

The computer system 100 may include one or more processors 170, each of which may include multiple cores, any of which may be single or multi-threaded. The one or more processors 170 may include a logical processor (e.g., under symmetric multi-threading). The computer system 100 may also include one or more persistent storage devices 150 (e.g., optical storage, magnetic storage, hard drive, tape drive, solid state memory, etc.) and one or more memories 110 (e.g., one or more of cache, SRAM, DRAM, RAM, SDRAM, EEPROM, etc.). Various embodiments may include fewer or additional components not illustrated in FIG. 1 (e.g., video cards, audio cards, additional network interfaces, peripheral devices, a network interface such as an ATM interface, an Ethernet interface, a Frame Relay interface, etc.).

The system components, including the one or more processors 170, memories 110, and persistent storage devices 150, may be connected via interconnects 140. The interconnects 140 may be implemented as any broadcast, point-to-point, or hybrid communication mechanism such as a front side bus, Ethernet, etc.

One or more of the system memories 110 may contain program instructions 120. Program instructions 120 may be executable to implement one or more applications 122 and the compiler 105 as described herein. Program instructions 120 may also include one or more operating systems 126 and/or runtime environments 124. Program instructions 120 may be encoded in platform native binary, any interpreted language such as Java byte-code, or in any other language such as C/C++, Java, etc. or in any combination thereof.

The applications 122 may include source code for compilation by the compiler 105 according to various embodiments described herein. A compiler 105 may perform any of the code transformations and optimizations described herein related to fault injection, including reducing run-time costs associated with fault injection. Runtime environment 124 may provide runtime support for multithreading, transactional memory, and/or support for virtual machines.

The system memory 110 may further include shared memory locations, which are referenced in FIG. 1 as shared memory 130, for storing variables and data structures. The compiler 105, applications 122, and/or any other programs defined by program instructions 120, may allocate and/or operate on variables and data structures contained in shared memory 130.

In example embodiments, the compiler 105 of the present application may include generating an injection table data structure (or injection table) when compiling code. Specifically, while machine code is compiled from source code, the compiler 105 may create entries within an injection table corresponding to respective injection points, which may be defined by a name parameter and, when a variable is present, a variable parameter. In example embodiments, the injection table may include fields for recording respective properties for each injection point. The fields of the injection table may include a name field, which provides the name parameter. The fields of the injection table may include a program counter field, which identifies a program counter address corresponding to the fault injection point within the generated machine code. The fields of the injection table may include an additional code field, which includes any additional instructions executable to compute the storage address of the variable in response to the variable being determined to have a complex variable reference. The fields of the injection table may include a variable location field, which specifies a storage address for the variable. The fields of the injection table may include a variable type field, which specifies a size and/or type of the variable.

In the absence of a fault injection, the generated code executes normally, with no additional run-time costs incurred. The primary overhead is associated with ensuring that the variable is live and potentially computing its address for complex variable references, provided these are supported by the compiler.

In regard to the additional code field, this entry in the injection table indicates whether the compiler 105 is to generate extra machine code to handle the fault injection at the specified point. The generation of additional code typically arises in more complex scenarios where the variable or fault injection point involves intricate data structures or nested references. For straightforward cases where the fault injection point directly involves a local variable or a simple register, no additional code is generally needed. The compiler 105 can directly insert the fault injection logic without further computation or adjustments. However, in more complex scenarios, the variable involved might be part of a nested data structure or use multiple levels of indirection to access. For example, accessing a field within a nested structure might lead to additional instructions to navigate through pointers and offsets. In such cases, the entry in the additional code field signifies the presence of such extra instructions. For instance, machine code might be generated to compute the address of the variable by dereferencing pointers or adjusting offsets. These additional instructions ensure that the correct memory location is accessed and manipulated in relation to the fault injection.

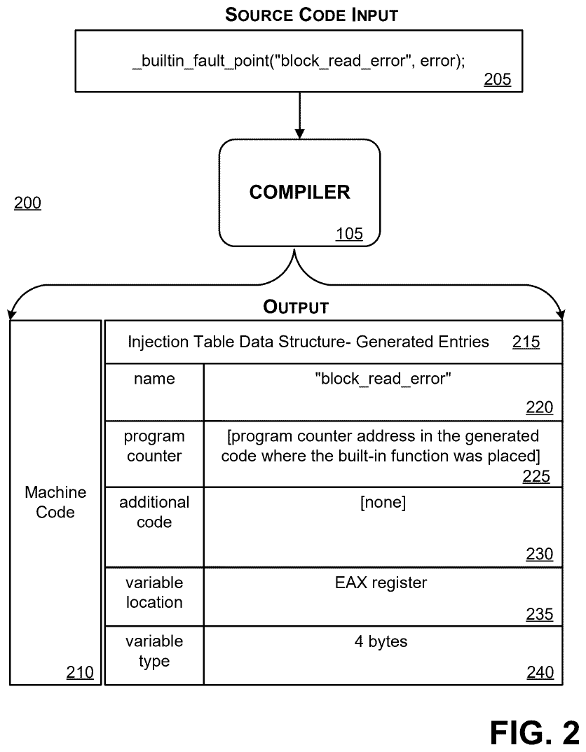

With reference now to FIGS. 2-5, several examples of injection table entries will be provided to further demonstrate functionality of the compiler 105 according to example embodiments. Each example will show how the built-in function can appear in source code. From there, example injection table entries for each built-in function will be provided and discussed.

FIG. 2 provides an example diagram 200 demonstrating the compilation of an injection point according to various embodiments. In this case, the built-in function appears in source code 205 as follows:
_builtin_fault_point(“block_read_error”, error);

According to example embodiments, the built-in function includes both an injection point name or name parameter, “block_read_error,” and a local variable, error, whose value can be set by the fault injection code. This allows the test to simulate an error condition at the specified point in the code, which, as will be appreciated, provides a controlled way to test the program's error-handling capabilities. Continuing with the example, in compiling the source code 205 associated with the injection point, the compiler 105 generates machine code 210 and injection table entries 215 for storage within an injection table. Given the source code 205 of the example injection point, the compiler 105 may be configured to generate the following injection table entries 215:

| | |
|---|---|
| Name Field: | “block_read_error” |
| Program Counter Field: | [program counter address |
| | in the generated code where |
| | the built-in function was |
| | placed] |
| Additional Code Field: | [none] |
| Variable Location Field: | EAX register |
| Variable Type Field: | 4 bytes |

According to example embodiments, the generated table entries 215 document properties related to a fault injection point, which can then be used in implementing the desired fault injection in the compiled machine code. For example, as indicated, the entry 220 generated in the name field includes the name parameter for specifying the injection point within the source code. The entry 225 in the program counter field identifies the location in the generated machine code where the injection point occurs, which is given generically in the table as “the program counter address in the generated code where the built-in function was placed.” In operation, the relevant program counter address would be provided. The entry 230 in the additional code field signifies whether extra instructions have been generated by the compiler 105 to compute a complex variable address. In this case, the entry 230 is provided as none, which indicates that no additional code is needed (e.g., because the variable address is determined as not being complex). The variable location field indicates where the variable is stored. In this case, the entry 235 is given as an EAX register. And, finally, the entry 240 in the variable type field specifies the size and/or type of the variable, which, as indicated, is given as 4 bytes, a typical size for an integer on the x86 architecture. Note that while the variable location and type provided in this example reflect typical values, the values may vary based on specific implementation details.

By generating this metadata, the compiler 105 of the present application provides a structured and organized method to manage fault injection points, which helps to ensure that error conditions can be accurately simulated, aiding in the thorough testing of error-handling mechanisms without requiring changes to the original source code. Further, the injection table can allow developers and testers to quickly identify and manipulate injection points, enhancing the efficiency and effectiveness of the testing process while minimizing or eliminating associated run-time costs.

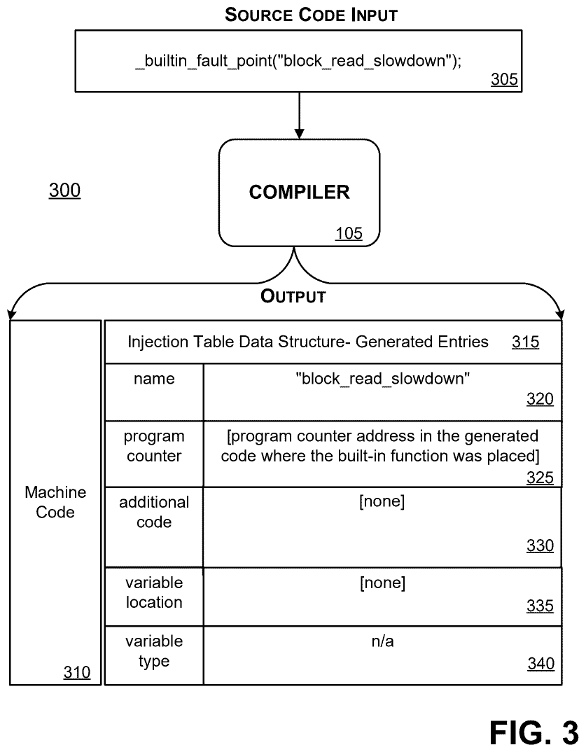

FIG. 3 provides an example diagram 300 demonstrating the compilation of an injection point according to various embodiments. In this case, the built-in function appears in source code 305 as follows:
_builtin_fault_point(“block_read_slowdown”);

According to example embodiments, the built-in function includes an injection point name or name parameter, “block_read_slowdown”, but no variable is included. This is because the injection point is being used to introduce a delay fault (or delay) rather than set an error code. As will be appreciated, a delay can be useful for testing performance degradation or timing-related issues without altering the program's logical flow. Continuing with the example, in compiling the source code 305 associated with the injection point, the compiler 105 may generate machine code 310 and injection table entries 315 for storage within an injection table. Given the source code 305 of the example injection point, the compiler 105 may be configured to generate the following injection table entries 315:

| | |
|---|---|
| Name Field: | “block_read_slowdown” |
| Program Counter Field: | [program counter address |
| | in the generated code where |
| | the built-in function was |
| | placed] |
| Additional Code Field: | [none] |
| Variable Location Field: | [none] |
| Variable Type Field: | [none] |

In this way, according to example embodiments, properties related to the fault injection point are generated as injection table entries 315, which can then be used in implementing the desired fault injection in the compiled machine code. For example, as indicated, the entry 320 generated in the name field includes the name parameter for specifying the injection point within the code. The entry 325 in the program counter field identifies the location in the generated machine code where the injection point occurs, which is given generically in the table as “the program counter address in the generated code where the built-in function was placed.” In operation, the relevant program counter address would be provided. The Name Field identifies the specific injection point within the code, and the program counter field records the location in the generated machine code where the injection occurs, allowing control over when the delay is introduced during execution. The other entries are not applicable given the lack of a variable in the example of FIG. 3. Specifically, the entry 330 in the additional code field signifies whether extra instructions have been generated by the compiler 105 to compute a complex variable address. In this case, the entry 330 is provided as none, which indicates that no additional code is needed, e.g., because there is no variable or, for that matter, a variable address given the nature of the delay fault. The entry 335 in the variable location field indicates where the variable is stored. Again, because there is no variable related to this injection fault, no variable location is given in the table entry. And, finally, the entry 340 in the variable type field specifies the size and/or type of the variable, which, as indicated, is indicated as being none because the example lacks a variable. By generating this metadata, the compiler 105 of the present application provides a structured and organized method to manage fault injection points. Changes to the original source code are not needed and run-time costs are minimized or eliminated.

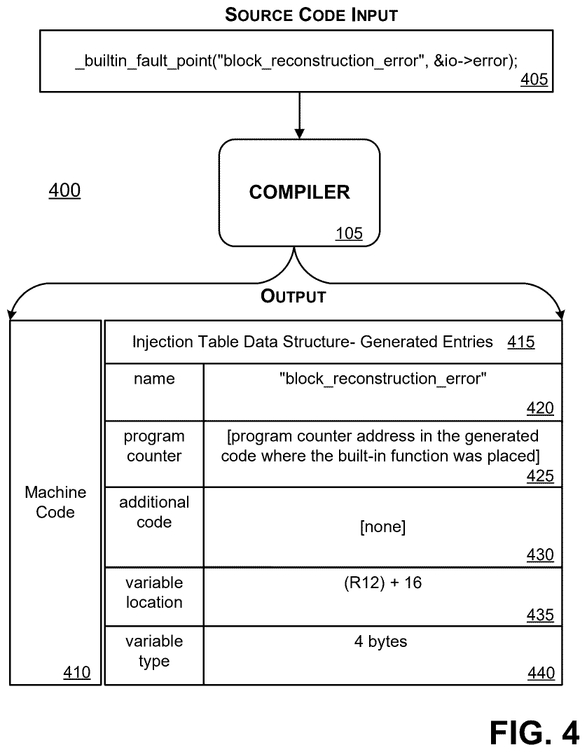

FIG. 4 provides an example diagram 400 demonstrating the compilation of an injection point according to various embodiments. In this case, the built-in function appears in source code 405 as follows:
_builtin_fault_point(“block_reconstruction_error”, &io->error);

In this case, the error code is a field within a structure pointed to by a local variable. The builtin function takes the injection point name, “block_reconstruction_error”, and a pointer to the error field within the structure io. This demonstrates the function's capability to handle more complex variable references, enabling fault injection into nested data structures. According to example embodiments, the built-in function includes an injection point name or name parameter, “block_reconstruction_error”. Continuing with the example, in compiling the source code 405 associated with the injection point, the compiler 105 generates machine code 410 and injection table entries 415 for storage within an injection table. Given the source code 405 of the example injection point, the compiler 105 may be configured to generate the following injection table entries 415:

| | |
|---|---|
| Name Field: | “block_reconstruction_error” |
| Program Counter Field: | [program counter address |
| | in the generated code where |
| | the built-in function was |
| | placed] |
| Additional Code Field: | [none] |
| Variable Location Field: | (R12) + 16 |
| Variable Type Field: | 4 bytes |

In this way, according to example embodiments, the generated table entries 415 document properties related to a fault injection point, which can then be used in implementing the desired fault injection in the compiled machine code. For example, as indicated, the entry 420 generated in the name field includes the name parameter for specifying the injection point within the code. The entry 425 in the program counter field identifies the location in the generated machine code where the injection point occurs, which is given generically in the table as “the program counter address in the generated code where the built-in function was placed.” In operation, the relevant program counter address would be provided. The entry 430 in the additional code field signifies whether extra instructions have been generated by the compiler 105 to compute a complex variable address. In this case, the entry 430 is provided as none, which indicates that no additional code is needed (e.g., because the variable address is determined as not being complex). The variable location field indicates where the variable is stored. In this case, the entry 435 is given as (R12)+16, which indicates an offset of 16 from the R12 register. And, finally, the entry 440 in the variable type field specifies the size and/or type of the variable, which, as indicated, is given as 4 bytes, a typical size for an integer on the x86 architecture.

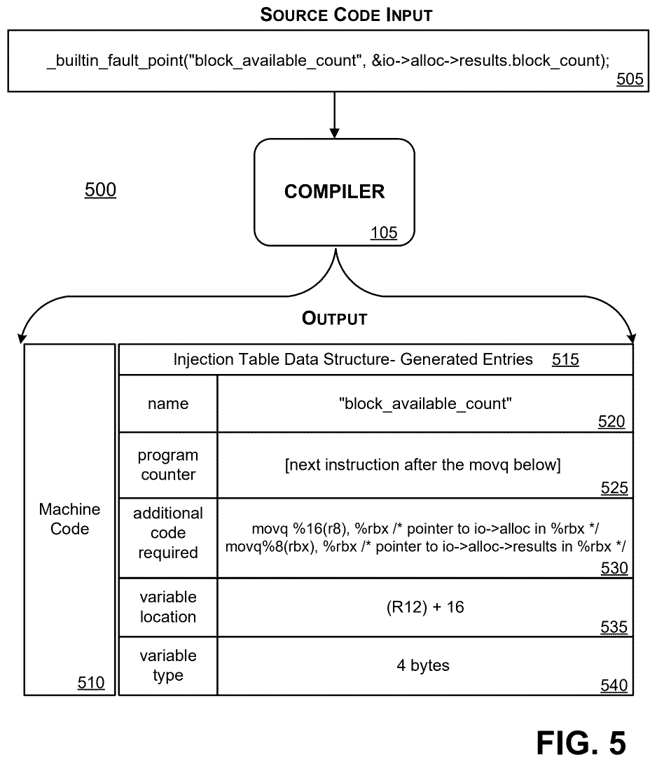

FIG. 5 provides an example diagram 500 demonstrating the compilation of an injection point according to various embodiment. In this case, the built-in function appears in source code 505 as follows:
_builtin_fault_point(“block_available_count”, &io->alloc->results.block_count);

This example shows the function being used with an error code that is actually a counter. The injection point name is “block_available_count”, and the function manipulates the block_count field within a structure accessed through multiple pointer indirections. This type of flexibility may allow the built-in function to target any integer variable within the program's data structures, regardless of depth. According to example embodiments, the built-in function includes both an injection point name and name parameter, “block_available_count”. Continuing with the example, in compiling the source code 505 associated with the injection point, the compiler 105 generates machine code 510 and injection table entries 515 for storage within an injection table. Given the source code 505 of the example injection point, the compiler 105 may be configured to generate the following injection table entries 515:

| | |
|---|---|
| Name Field: | “block_available_count” |
| Program Counter Field: | [next instruction after the second movq below] |
| Additional Code Field: | movq %16 (r8), %rbx /* pointer to io->alloc in %rbx */ |
| | movq%8(rbx), %rbx /* pointer to io->alloc->results in %rbx */ |
| Variable Location Field: | (R12) + 16 |
| Variable Type Field: | 4 bytes |

According to example embodiments, the generated table entries 515 document properties related to a fault injection point, which can then be used in implementing the desired fault injection in the compiled machine code. As before, entry 520 in the name field identifies the specific injection point in the code, while the entry 525 in the program counter field records the address where the fault injection occurs in the generated machine code.

Unlike the other examples, in this case, the additional code field includes extra instructions generated by the compiler 105 to navigate to complex data structures and access the targeted variable. Put another way, the entry in the additional code field signifies that, in this case, extra instructions have been generated by the compiler 105 to compute a complex variable address, and those instructions are included in the table entry 530. The extra instructions provided in this example demonstrate how the compiler 105 may generate additional code to handle a complex variable reference. Specifically, the movq % 16(r8), orbx instruction moves the pointer to io->alloc into the rbx register, and the movq % 8(rbx), orbx instruction further dereferences this pointer to access the results structure within alloc. This additional generated machine code ensures that the correct memory location is accessed in performing fault injection according to example embodiments. Moving on to the remaining entries in the table, the entry 535 in the variable location field indicates where the variable is stored, in this case at an offset of 16 from the RBX register, and the entry 540 of the variable type field specifies the size of the variable.

By documenting these details in an injection table, the compiler 105 of the present application facilitates efficient fault injection testing. For example, developers and testers can refer to the injection table to understand and manipulate the injection points, ensuring that error conditions are accurately simulated and their impacts on the program's error-handling mechanisms are evaluated. The present method enhances the testing process by providing a clear and organized way to manage and utilize fault injection points, even in complex nested data structures, without impacting the program's logical flow or requiring significant changes to the source code, while also reducing or eliminating run-time cost. By integrating such functionality directly into the compiler 105, example embodiments streamline the process of fault injection, reducing the reliance on external testing tools and minimizing the performance overhead in the released code. The built-in nature of the function ensures consistent behavior across different builds, thus enhancing the reliability and efficiency of error recovery testing.

According to example embodiments, the process of fault injection may proceed according to the following operations. The process may include determining entries related to a fault injection point by searching an injection table by the name parameter of the injection point. In example embodiments, to assist with accuracy, the name parameter may be further disambiguated by incorporating additional identifiers such as the file name, function name, module name, or library name. In example embodiments, the process may further include replacing an instruction at the program counter address given in the injection table with an instruction designed to trigger the execution of the fault injection code. This replacement instruction may vary depending on the architecture, such as a single byte interrupt instruction in the x86 instruction set, a fixed-size instruction in the ARM architecture, or a more general variable-length jump instruction. The original instruction may be preserved for future use.

In example embodiments, when the specified injection point is executed, the process may further include transferring control from the program to the fault injection code by the CPU. At this point, according to example embodiments, the state of the program, including all user registers, may be saved to assist in accurately restoring the program after the fault injection process is complete. In example embodiments, the process may further include adjusting, via operation of the fault injection code and utilizing the variable location specified in the injection table entry, a value of the variable according to the fault being injected. In example embodiments, the variable location can be retrieved by looking up the program counter or can be embedded within the injection code itself. For instance, the injection code may set a register value or alter a memory location to simulate an error. For another example, where implicated, the fault injection code may introduce a delay for a specific period or until a certain event occurs. According to example embodiments, this functionality may be useful in testing race conditions where multiple threads or processes running on different CPU cores exhibit order-dependent behavior.

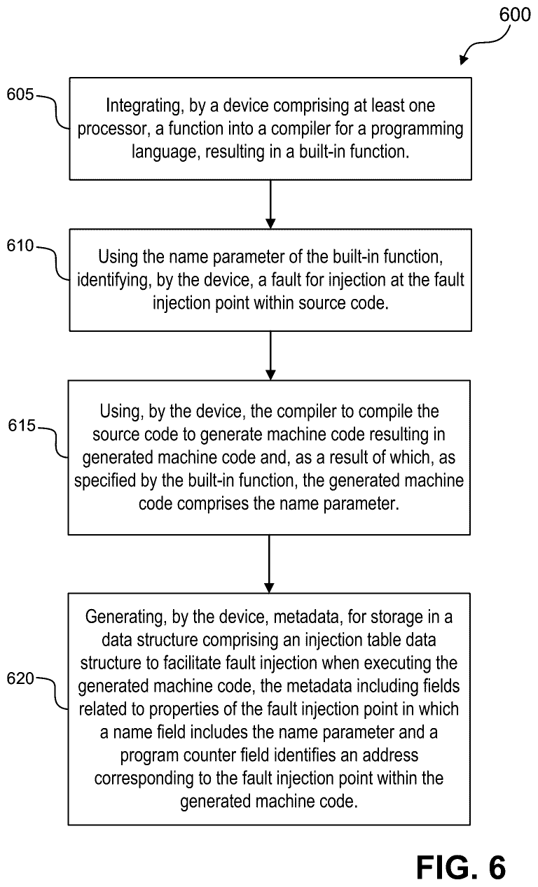

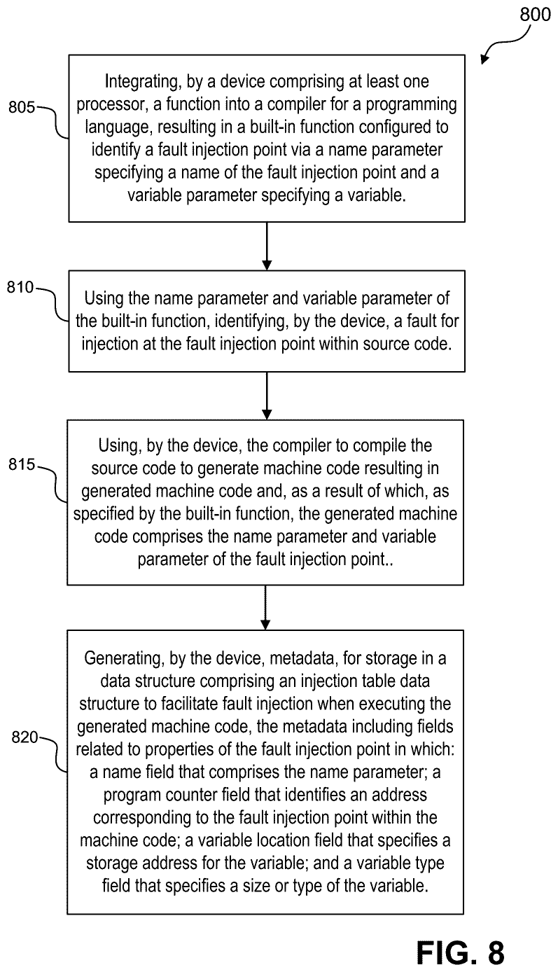

In example embodiments, following the adjustment of the variable value, the process may further include executing the instruction as modified by the fault-injecting code. In example embodiments, this operation may be achieved through various methods, including emulation, copying the instruction to another location for execution, or temporarily replacing the injection instruction with the original instruction and setting a single-step trap to trigger after execution. In example embodiments, the process may further include resuming execution of the program from the point immediately after the fault injection point. In example embodiments, the modified variable value, which resulted in the injection of the fault, remains part of the program's state and may influence subsequent program behavior. Further characteristics as to how the generated machine code is executed to effectuate fault injection are provided in relation to the example embodiments of FIGS. 6 and 8.

In example embodiments, the compiler 105 of the present application allows for constructs like the following to be utilized for fault injection without introducing additional instructions or altering the generated code compared to code generated without fault injection. Consider the example provided in the following construct:

error = function(parameters);
_builtin_fault_point(“funcfail1”, error);
If (error != 0)
{
/* error handling code here */
}

In this example, the function call function (parameters) assigns a value to the local variable error. The built-in function _builtin_fault_point(“funcfail1”, error) designates an injection point named “funcfail1” and associates it with the error variable. If a fault is injected at this point, the value of error can be manipulated to simulate different error conditions. The subsequent if (error!=0) statement checks the value of error and triggers appropriate error handling code where applicable. This construct compiles without adding extra instructions or changes to the generated code when fault injection is not used.

In example embodiments, more complex sequences can also be injected, such as in relation to the following construct:

function(parameters, &structure);
_builtin_fault_point(“funcfail2”, structure.error);
if (structure.error != 0) {
/* error handling goes here */
}

In this example, the function call function (parameters, &structure) modifies the structure variable, which contains an error field. The built-in function _builtin_fault_point (“funcfail2”, structure.error) creates an injection point named “funcfail2” and targets the structure.error field. For this to operate correctly, the compiler 105 should be capable of representing the address of the structure.error field in the injection table. This may be feasible for straightforward cases where the address is local to the function or where the base address can be found in a register. Alternatively, the compiler 105 may compute the address of the error location into a register. It is important to note that in such cases, the generated code with fault injection may still be no more costly in terms of run-time costs than without fault injection. This is because the address computation for the error value is part of the error check (if (structure.error!=0)) regardless of fault injection. The potential additional cost arises from the use of a register to have a longer lifetime, be spilled, or be recomputed if the error check does not immediately follow the injection point. In example embodiments, by supporting such constructs, the compiler 105 of the present application ensures that fault injection can be used with cases of differing complexity without affecting performance and/or without requiring extensive code modifications.

In the context of compiler design, the concepts of being “live” and “volatile” refer to characteristics of a variable that allow for accurate program execution and error-handling. As will be appreciated, being live refers to whether a variable is actively being used or has a meaningful value at a specific point in the program. A variable is considered “live” if its value may be read or used later. Otherwise, the variable is considered “dead.” Volatile, on the other hand, is a concept used in programming languages like C and C++ to prevent a compiler from optimizing away access to a variable, ensuring that the value of the variable is always read from and written to memory. This is significant for variables that may change unexpectedly, such as those affected by hardware or concurrent processes. In example embodiments, the compiler 105 is configured so that variables marked for fault injection are both live and treated as volatile at the point where the fault is injected. This approach ensures that the compiler 105 recognizes the potential for a variable to be modified, enabling fault injection while avoiding compromises in accuracy or efficiency in executing the generated code.

According to example embodiments, attention will now turn to functionality of the present compiler 105 that demonstrates how variables are maintained as live and volatile. A first example includes a case where an error is not possible without fault injection. That is, according to example embodiments, fault injection is used to inject a fault where no fault currently exists. The example code for this example is as follows:

```
int do_something(void)
{
  int error = 0;
  /* arbitrary actions which don't modify error */
  #if DEBUG /* the next line only applies to “debug” builds, not to normal
compilation */
    error = check_something( );
  #endif
  return error; /* always succeeds, without injection */
}
int call_the_thing(void)
{
  int error;
  error = do_something( ); /* compiler knows this always returns 0 */
  if (error != 0) { /* compiler knows this can never happen */
    handle_error( );
  }
  return error;
}
```

In this example code, written in C, the initial line int do_something (void) is a function declaration and definition, with int indicating that the function will return an integer value and do_something being the name of the function, which identifies the function and is used to call it elsewhere in the code. The term (void) means that the function takes no arguments. In C, the inclusion of void in the parameter list indicates that the function does not accept any parameters. The body of the function then follows. Within the body, the function starts by declaring and initializing an integer variable int error to zero. Then comments are provided that indicate that arbitrary actions occur, but also that these actions do not modify the error variable. Next follows a conditional compilation term. Specifically, the #if DEBUG preprocessor directive means that the code block within it is only compiled if DEBUG is defined. Inside this block, the function check_something( ) is called, and its return value is assigned to error. This code is excluded from the normal release build and only included in debug builds. In the return statement, the function always returns the error variable. Without fault injection, this return value will be 0 in the release build, because error remains zero.

Following that, the initial line int call_the_thing(void) is a function declaration and definition, with int indicating that the function will return an integer value with call_the_thing being the name of the function. With the following body portion of the function, an integer variable error is declared. The do_something function is called and assigns its return value to error. Since do_something always returns zero (in the release build), error will be zero. The if statement checks if error is not zero. Given that the compiler knows that do_something always returns zero in non-debug builds, this condition will never be true, and the code within the if block (handle_error( )) will never execute. The function returns the value of error, which is always zero.

Given this logic, a release build and a debug build will produce different outcomes. In the release build, do_something always returns zero because error is never modified. Further, call_the_thing checks the return value of do_something, but since do_something is always zero, handle_error is never called. The overall result is that both functions essentially perform no meaningful action in the release build, and error always remains zero. However, in a debug build (when DEBUG is defined), do_something can return a non-zero value if check_something( ) returns a non-zero value. This could cause call_the_thing to call handle_error if an error is detected, allowing error-handling logic to be tested during debugging.

In regard to compiling the example code, a conventional compiler would do so as follows:

```
call_the_thing:
  xor eax, eax /* zero eax */
  ret /* return */
```

As will be appreciated, in the compiled code, there is no call to handle_error because the conventional compiler knows that do_something never returns an error code (in a non-debug build) because it always returns zero. Consequently, it may become difficult to test whether handle_error works, except in a special debugging build.

In example embodiments, to enable fault injection, the present compiler 105 may be configured to recognize that the error could be modified, even though it is always zero without injection in a normal build. According to example embodiments, the same code is presented with a fault injection point added via the built-in function, as follows:

```
int do_something(void)
{
  int error = 0;
  /* arbitrary actions which do not modify error */
  #if DEBUG /* the next line only applies to “debug” builds, not to normal
compilation */
    error = check_something( );
  #endif
  _builtin_fault_point(“do_something”, error);
  return error; /* always succeeds, without injection */
}
int call_the_thing(void)
{
  int error;
  error = do_something( ); /* compiler knows this always returns 0 */
  if (error != 0) { /* compiler knows this can never happen */
    handle_error( );
  }
  return error;
}
```

According with example embodiments, the code generated by the compiler 105 for a non-debug build may include:

```
call_the_thing:
  xor eax, eax /* zero eax */
@0:
  test eax, eax /* still zero? * /
  jnz @1 /* if not zero, handle it */
  ret /* zero, just return */
@1:
  push eax /* save error */
  call handle_error
  pop eax /* restore error to return the right (injected) code */
  ret
```

In this scenario, according to example embodiments, the fault injection table may contain an entry for do_something at the @0 label, indicating that the error code is in eax. This example illustrates an instance in which fault injection may not be zero-cost, as, in this case, the fault injection enables the testing of a situation where an error might occur, even though one was not possible before. Thus, the error code is tested even though, without fault injection, no error would be possible. In accordance with example embodiments, this may allow an error path to be tested even where that error is not currently possible. As will be appreciated, this type of functionality may be useful in development or for testing error handling in released code where only a debug version can detect the error.

In accordance with example embodiments, the following illustrates an alternative fault injection scenario in which run-time cost are eliminated. In this case, unlike the above example, an error was possible. Here, the same example from above is used, but the #if DEBUG is removed, which allows the check_something to be called in release builds. Accordingly, the generated code without fault injection becomes:

```
call_the_thing:
  call check_something /* checks for an error, returns result in eax register */
@0:
  test eax, eax /* is there a (non-zero) error code? * /
  jnz @1 /* if so, handle it */
  ret /* no error, just return */
@1:
  push eax /* save error */
  call handle_error
  pop eax /* restore error to return the right (injected) code */
  ret
```

In example embodiments, with enablement of fault injection, the fault injection table again may contain an entry for do_something at @0 and eax. In this case, though, the generation of additional code is not needed. Thus, the fault injection may proceed by modifying the contents of the eax register at location @0 when enabled. There is no additional code needed because the error test is already part of the process. In this way, by maintaining liveness and treating variables as volatile, the compiler 105 of the present application may facilitate fault injection having no run-time cost. Developers can test error-handling mechanisms without significantly altering the original code or adding unnecessary instructions, which may make the testing process more efficient and robust.

Referring now to FIG. 6, a method 600 is illustrated for compiling source code that includes a fault injection in which the fault does not include a variable according to example embodiments. For example, the fault being injected may be a delay fault.

At 605, the method 600 may include integrating, by a device comprising at least one processor, a function into a compiler for a programming language, resulting in a built-in function. According to example embodiments, the built-in function may be configured to identify a fault injection point based on a name parameter specifying a name of the fault injection point.

At 610, the method 600 may include using the name parameter of the built-in function, identifying, by the device, a fault for injection at the fault injection point within source code.

At 615, the method 600 may include using, by the device, the compiler to compile the source code to generate machine code resulting in generated machine code and, as a result of which, as specified by the built-in function, the generated machine code comprises the name parameter.

At 620, the method 600 may include generating, by the device, metadata, for storage in a data structure comprising an injection table data structure to facilitate fault injection when executing the generated machine code. The metadata may include fields related to properties of the fault injection point. The fields may include a name field that comprises the name parameter and a program counter field that identifies an address corresponding to the fault injection point within the generated machine code.

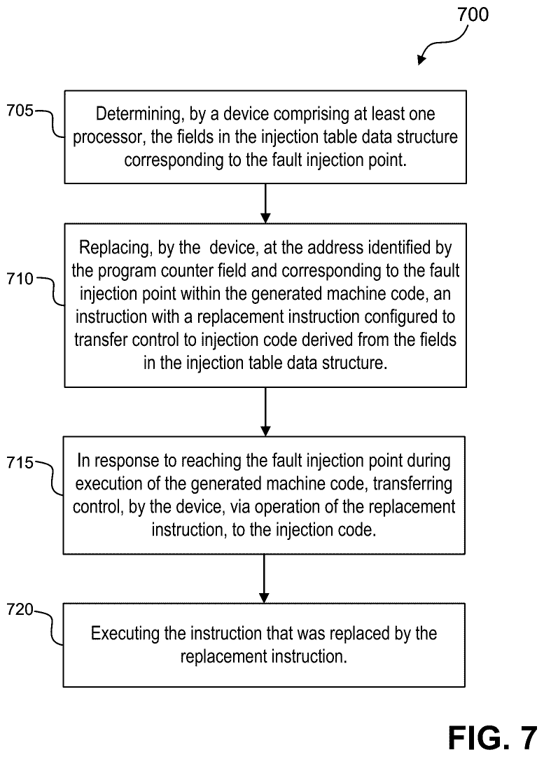

Referring now to FIG. 7, a method 700 is illustrated for executing the machine code generated by the compilation in FIG. 6 according to example embodiments.

At 705, the method 700 may include, by a device comprising at least one processor, determining the fields in the injection table data structure corresponding to the fault injection point.

At 710, the method 700 may include replacing, by the device, at the address identified by the program counter field and corresponding to the fault injection point within the generated machine code, an instruction with a replacement instruction configured to transfer control to injection code derived from the fields in the injection table data structure.

At 715, the method 700 may include, in response to reaching the fault injection point during execution of the generated machine code, transferring, by the device, control, via operation of the replacement instruction, to the injection code.

At 720, the method 700 may include executing, by the device, the instruction that was replaced by the replacement instruction. In example embodiments, the executing of the instruction that was replaced by the replacement instruction may include emulating the instruction, copying the instruction to a different location for execution, or temporarily replacing the replacement instruction with the instruction and setting a single-step trap to trigger after execution of the instruction.

Referring now to FIG. 8, a method 800 is illustrated for compiling source code that includes a fault injection in which the fault includes a variable according to example embodiments.

At 805, the method 800 may include integrating, by a device comprising at least one processor, a function into a compiler for a programming language to result in a built-in function. The built-in function may be configured to identify a fault injection point via parameters that include a name parameter specifying a name of the fault injection point and a variable parameter specifying a variable.

At 810, the method 800 may include identifying, by the device, using the name parameter and the variable parameter, a fault for injection at a fault injection point within source code.

At 815, the method 800 may include using, by the device, the compiler to compile the source code to generate machine code as a result of which, as specified by the built-in function, the machine code includes the name parameter and variable parameter of the fault injection point.

At 820, the method 800 may include generating, by the device, metadata in a data structure comprising an injection table data structure to facilitate a fault injection process applicable during execution of the machine code. The metadata may include fields related to properties of the fault injection point. The fields may include a name field that comprises the name parameter. The fields may further include a program counter field that identifies an address corresponding to the fault injection point within the machine code. The fields may further include a variable location field that specifies a storage address for the variable. The fields may further include a variable type field that specifies a size or type of the variable.

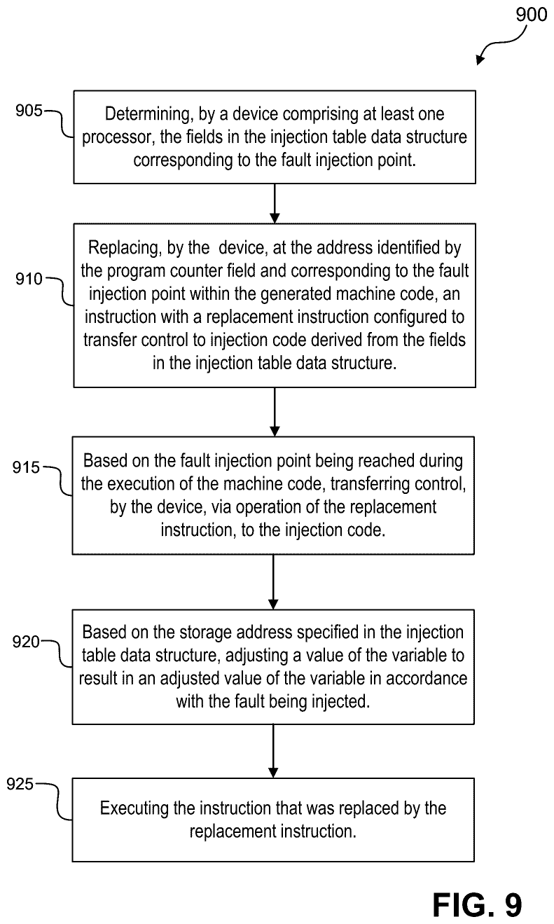

Referring now to FIG. 9, a method 900 is illustrated for executing the machine code generated via the compilation of FIG. 8 according to example embodiments.

At 905, the method 900 may include determining, by a device comprising at least one processor, the fields in the injection table data structure that correspond to the fault injection point.

At 910, the method 900 may include replacing, by the device, at the program counter address corresponding to the fault injection point within the machine code, an instruction with a replacement instruction configured to transfer control to injection code derived from the fields from the injection table data structure.

At 915, the method 900 may include, based on the fault injection point being reached during the execution of the machine code, transferring, by the device, control, via operation of the replacement instruction, to the injection code.

At 920, the method 900 may include, based on the storage address specified in the injection table data structure, adjusting, by the device, a value of the variable to result in an adjusted value of the variable in accordance with the fault being injected.

At 925, the method 900 may include executing the instruction that was replaced by the replacement instruction. In example embodiments, the executing of the instruction that was replaced by the replacement instruction may include emulating the instruction, copying the instruction to a different location for execution, or temporarily replacing the replacement instruction with the instruction and setting a single-step trap to trigger after execution of the instruction. In example embodiments, the execution of the generated machine code may continue at a point subsequent to the fault injection point with the adjusted value of the variable remaining a part of a state of the executing of the generated machine code resulting in subsequent behavior of the executing of the generated machine code being affected, based on the adjusted value, at the point subsequent to the fault injection point.

In example embodiments, the metadata generated in the injection table data structure for the fault injection point may further comprise an additional code field specifying additional instructions executable to compute the storage address of the variable in response to the variable being determined to have a complex variable reference. A complex variable reference, for example, may include a variable being nested within a structure or array, a request to access the variable using pointers or references other than pointers, or a variable being stored in dynamically allocated memory.

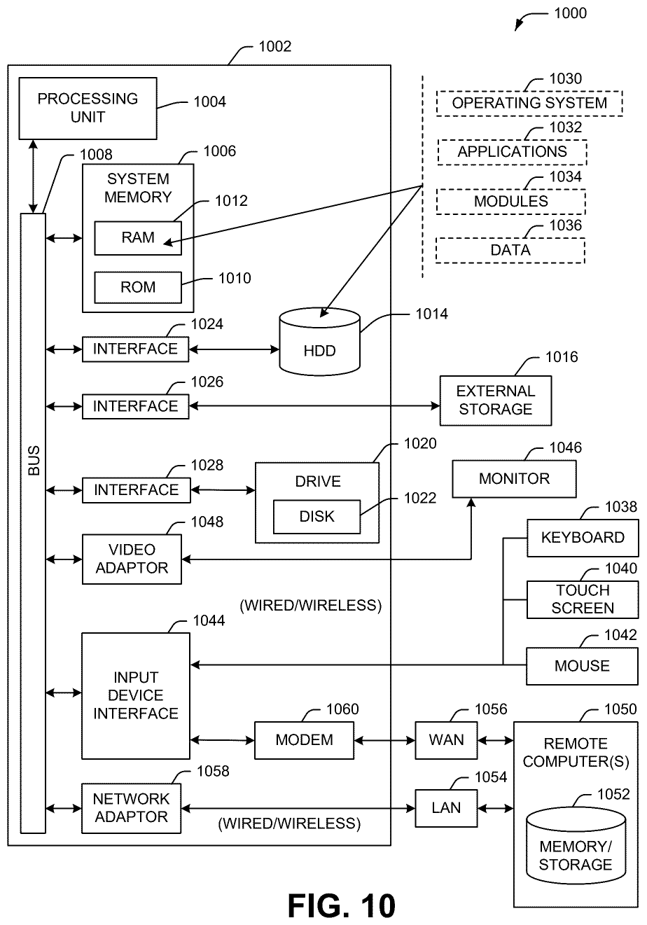

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 may couple system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid-state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

What is claimed is:

1. A method, comprising:
integrating, by a device comprising at least one processor, a function into a compiler for a programming language, resulting in a built-in function, wherein the built-in function is configured to identify a fault injection point based on a name parameter specifying a name of the fault injection point;
using the name parameter of the built-in function, identifying, by the device, a fault for injection at the fault injection point within source code;
using, by the device, the compiler to compile the source code to generate machine code resulting in generated machine code and, as a result of which, as specified by the built-in function, the generated machine code comprises the name parameter;
generating, by the device, metadata, for storage in a data structure comprising an injection table data structure to facilitate fault injection when executing the generated machine code, the metadata comprising fields related to properties of the fault injection point, and the fields comprising:
a name field that comprises the name parameter, and
a program counter field that identifies an address corresponding to the fault injection point within the generated machine code; and
executing, by the device the generated machine code, comprising:
determining the fields in the injection table data structure corresponding to the fault injection point,
replacing, at the address identified by the program counter field and corresponding to the fault injection point within the generated machine code, an instruction with a replacement instruction configured to transfer control to injection code derived from the fields in the injection table data structure,
in response to reaching the fault injection point during execution of the generated machine code, transferring control, via operation of the replacement instruction, to the injection code, and
executing the instruction that was replaced by the replacement instruction.

2. The method of claim 1, wherein the fault comprises a delay introduced at the fault injection point.

3. The method of claim 1, wherein the fault of the fault injection point comprises a variable,
wherein the built-in function in the compiler is configured to identify the fault injection point via the name parameter and a variable parameter specifying the variable,
wherein the fault for the injection at the fault injection point is identified, using the built-in function, within the source code by the name parameter and the variable parameter,
wherein the generated machine code comprises the name parameter and the variable parameter,
wherein the metadata in the injection table data structure for the fault injection point further comprises a variable location field specifying a storage address for the variable, and
wherein the injection code is configured to utilize the storage address specified in the injection table data structure to adjust a value of the variable resulting in an adjusted value of the variable in accordance with the fault.

4. The method of claim 3, wherein the metadata in the injection table data structure for the fault injection point further comprises a variable type field specifying a size or type of the variable.

5. The method of claim 3, wherein the executing of the instruction that was replaced by the replacement instruction comprises one of emulating the instruction, copying the instruction to a different location for execution, or temporarily replacing the replacement instruction with the instruction and setting a single-step trap to trigger after execution of the instruction.

6. The method of claim 3, wherein the executing of the generated machine code further comprises:
continuing the executing of the generated machine code at a point subsequent to the fault injection point with the adjusted value of the variable remaining a part of a state of the executing of the generated machine code resulting in subsequent behavior of the executing of the generated machine code being affected, based on the adjusted value, at the point subsequent to the fault injection point.

7. The method of claim 3, wherein the metadata in the injection table data structure for the fault injection point further comprises an additional code field specifying additional instructions executable to compute the storage address of the variable in response to the variable being determined to have a complex variable reference.

8. The method of claim 7, wherein the complex variable reference comprises one of:
the variable being nested within a structure or array,
a request to access the variable using pointers or references other than pointers, or
the variable being stored in dynamically allocated memory.

9. A system, comprising:
at least one processor; and
at least one memory that stores executable instructions that, when executed by the at least one processor, facilitate performance of operations, comprising:
integrating a function into a compiler for a programming language, resulting in a built-in function, wherein the built-in function is configured to identify a fault injection point based on a name parameter specifying a name of the fault injection point;
using the name parameter of the built-in function, identifying, by the device, a fault for injection at the fault injection point within source code;
using, by the device, the compiler to compile the source code to generate machine code resulting in generated machine code and, as a result of which, as specified by the built-in function, the generated machine code comprises the name parameter;
generating, by the device, metadata for storage in an injection table data structure to facilitate fault injection when executing the generated machine code, the metadata comprising fields related to properties of the fault injection point, and the fields comprising:
a name field that comprises the name parameter, and
a program counter field that identifies an address corresponding to the fault injection point within the generated machine code; and
executing, by the device the generated machine code, comprising:
determining the fields in the injection table data structure corresponding to the fault injection point,
replacing, at the address identified by the program counter field and corresponding to the fault injection point within the generated machine code, an instruction with a replacement instruction configured to transfer control to injection code derived from the fields in the injection table data structure,
in response to reaching the fault injection point during execution of the generated machine code, transferring control, via operation of the replacement instruction, to the injection code, and
executing the instruction that was replaced by the replacement instruction.

10. The system of claim 9, wherein the fault comprises a delay introduced at the fault injection point.

11. The system of claim 9, wherein the fault of the fault injection point comprises a variable,
wherein the built-in function in the compiler is configured to identify the fault injection point via the name parameter and a variable parameter specifying the variable,
wherein the fault for the injection at the fault injection point is identified, using the built-in function, within the source code by the name parameter and the variable parameter,
wherein the generated machine code comprises the name parameter and the variable parameter,
wherein the metadata in the injection table data structure for the fault injection point further comprises a variable location field specifying a storage address for the variable, and
wherein the injection code is configured to utilize the storage address specified in the injection table data structure to adjust a value of the variable resulting in an adjusted value of the variable in accordance with the fault.

12. The system of claim 11, wherein the metadata in the injection table data structure for the fault injection point further comprises a variable type field specifying a size or type of the variable.

13. The system of claim 11, wherein the executing of the instruction that was replaced by the replacement instruction comprises one of emulating the instruction, copying the instruction to a different location for execution, or temporarily replacing the replacement instruction with the instruction and setting a single-step trap to trigger after execution of the instruction.

14. The system of claim 11, wherein the executing of the generated machine code further comprises:
continuing the executing of the generated machine code at a point subsequent to the fault injection point with the adjusted value of the variable remaining a part of a state of the executing of the generated machine code resulting in subsequent behavior of the executing of the generated machine code being affected, based on the adjusted value, at the point subsequent to the fault injection point.

15. The system of claim 11, wherein the metadata in the injection table data structure for the fault injection point further comprises an additional code field specifying additional instructions executable to compute the storage address of the variable in response to the variable being determined to have a complex variable reference.

16. The system of claim 15, wherein the complex variable reference comprises one of:
the variable being nested within a structure or array,
a request to access the variable using pointers or references other than pointers, or
the variable being stored in dynamically allocated memory.

17. A non-transitory machine-readable medium, comprising executable instructions that, when executed by at least one processor, facilitate performance of operations, comprising:
integrating a function into a compiler for a programming language to result in a built-in function, wherein the built-in function is configured to identify a fault injection point via parameters, the parameters comprising:
a name parameter specifying a name of the fault injection point, and
a variable parameter specifying a variable;
identifying, using the name parameter and the variable parameter, a fault for injection at a fault injection point within source code;
using the compiler to compile the source code to generate machine code as a result of which, as specified by the built-in function, the machine code comprises the name parameter and variable parameter of the fault injection point;
generating metadata in a data structure comprising an injection table data structure to facilitate a fault injection process applicable during execution of the machine code, the metadata comprising fields related to properties of the fault injection point, the fields comprising:
a name field that comprises the name parameter,
a program counter field that identifies an address corresponding to the fault injection point within the machine code,
a variable location field that specifies a storage address for the variable, and
a variable type field that specifies a size or type of the variable; and
executing the machine code comprising:
determining the fields in the injection table data structure that correspond to the fault injection point,
replacing, at the program counter address corresponding to the fault injection point within the machine code, an instruction with a replacement instruction configured to transfer control to injection code derived from the fields from the injection table data structure, and
based on the fault injection point being reached during the execution of the machine code, transferring control, via operation of the replacement instruction, to the injection code, the injection code being configured to utilize the storage address specified in the injection table data structure to adjust a value of the variable to result in an adjusted value of the variable in accordance with the fault being injected, and
executing the instruction that was replaced by the replacement instruction.

18. The non-transitory machine-readable medium of claim 17, wherein the executing of the instruction that was replaced by the replacement instruction comprises one of emulating the instruction, copying the instruction to a different location for execution, or temporarily replacing the replacement instruction with the instruction and setting a single-step trap to trigger after execution of the instruction.

19. The non-transitory machine-readable medium of claim 17, wherein the executing of the generated machine code further comprises:
continuing the executing of the generated machine code at a point subsequent to the fault injection point with the adjusted value of the variable remaining a part of a state of the executing of the generated machine code resulting in subsequent behavior of the executing of the generated machine code being affected, based on the adjusted value, at the point subsequent to the fault injection point.

20. The non-transitory machine-readable medium of claim 17, wherein the metadata in the injection table data structure for the fault injection point further comprises an additional code field specifying additional instructions executable to compute the storage address of the variable in response to the variable being determined to have a complex variable reference.
